(19) United States
(12) Patent Application Publication
(10) Pub. No.: US 2008/0036847 A1
(43) Pub. Date: Feb. 14, 2008

(54) Image Reading Apparatus, Image Forming Apparatus, and Image Reading Method

(75) Inventor: Koji Kawai, Shizuoka-ken (JP)

Correspondence Address: SoCAL IP LAW GROUP LLP, 310 N. WESTLAKE BLVD. STE 120, WESTLAKE VILLAGE, CA, 91362, US

(73) Assignees: Kabushiki Kaisha Toshiba, Minato-ku (JP); Toshiba Tec Kabushiki Kaisha, Shinagawa-ku (JP)

(21) Appl. No.: 11/464,414

(22) Filed: Aug. 14, 2006

(51) Int. Cl. B41J 2/47

(52) U.S. Cl. 347/232

(57) ABSTRACT

In an image reading apparatus according to the present invention; an image reading apparatus for reading a color original includes: plural light sources of different colors; a monochrome image sensor configured to detect reflected light from the color original; an image generating unit configured to generate plural image data corresponding to the colors of the plural light sources from a reading signal outputted from the monochrome image sensor; and a control unit configured to turn on the light sources one by one and cause the image generating unit to generate, one by one, the image data corresponding to the colors of the light sources. With the image reading apparatus according to the present invention, good image quality can be realized even in the case of reading a color original as a color image by using one monochrome image sensor.

### BACKGROUND OF THE INVENTION

1. Technical Field of the Invention

The present invention relates to an image reading apparatus, image forming apparatus and image reading method, and particularly to an image reading apparatus, image forming apparatus and image reading method for reading a color original.

2. Related Art

For reading a color original as a color image, there is a method using a color image sensor (first method). It is a method of irradiating a color original with one type of light source and reading the reflected light from the color original as a color image, for example, by using three types of CCD image sensors corresponding to the primary colors R, G and B. In this case, a color image is formed from the three image data of R, G and B that are read simultaneously.

On the other hand, there is also a method of reading a color original as a color image by using one monochrome image sensor and plural light sources of different colors (second method). It is a method of irradiating a color original while sequentially switching, for example, three light sources of R, G and B in a short time, and reading the image by the one monochrome image sensor. In this case, the output from the monochrome image sensor is split into three image data of R, G and B in accordance with the irradiation timing of each light source, and after that, a color image is formed.

The first method tends to provide higher image quality than the second method, but since it uses three image sensors, the cost of the image sensors is higher than in the second method. Also, the processing to the image sensor outputs is broader than in the second method in terms of the range of processing carried out in parallel to the image data of three colors, and this increases hardware size and software size.

On the other hand, in the second method, the cost of the image sensor is lower and the processing to the image sensor output can be carried out in one system to a certain extent. Therefore, hardware size and software size can be smaller than in the first method.

However, in the second method, since the three light sources of R. G and B are sequentially switched in a short time during the processing, the resulting image data of three colors are temporally thinned out, resulting in poor image quality compared with image quality acquired by the first method.

### SUMMARY OF THE INVENTION

In view of the foregoing circumstances, it is an object of the present invention to provide an image reading apparatus, image forming apparatus and image reading method that can realize good image quality even when reading a color original as a color image by using one monochrome image sensor.

To achieve the above object, an image reading apparatus according to an aspect of the present invention is an image reading apparatus for reading a color original and it includes: plural light sources of different colors; a monochrome image sensor configured to detect reflected light from the color original; an image generating unit configured to generate plural image data corresponding to the colors of the plural light sources from a reading signal outputted from the monochrome image sensor; and a control unit configured to turn on the light sources one by one and cause the image generating unit to generate, one by one, the image data corresponding to the colors of the light sources.

To achieve the above object, an image forming apparatus according to an aspect of the present invention is an image forming apparatus for reading a color original and forming a color image, and it includes: plural light sources of different colors; a monochrome image sensor configured to detect reflected light from the color original; an image generating unit configured to generate plural image data corresponding to the colors of the plural light sources from a reading signal outputted from the monochrome image sensor; a control unit configured to turn on the light sources one by one and cause the image generating unit to generate, one by one, the image data corresponding to the colors of the light sources; an image data combining unit configured to combine the plural image data and thus generate a color image; and an image forming unit configured to print the combined color image onto a recording medium.

To achieve the above object, an image reading method according to an aspect of the present invention is an image reading method for reading a color original and it includes the steps of: turning on plural light sources of different colors one by one and irradiating the color original; detecting reflected light from the color original by using a monochrome image sensor; and generating, one by one, the image data corresponding to the colors of the light sources at the turning on of each of the light sources, from a reading signal outputted from the monochrome image sensor.

### BRIEF DESCRIPTION OF THE DRAWINGS

In the attached drawings,

FIGS. 1A and 1B are views showing typical exemplary configurations of an image reading apparatus that reads a color original as a color image;

FIG. 2 is a view for explaining a basic operation in a case of reading a color original by using a monochrome image sensor;

FIG. 3 is a view for explaining lowering of resolution in a case of reading a color original by using a monochrome image sensor;

FIG. 4 is a sectional view showing an exemplary structure of an image reading apparatus according to a first embodiment of the present invention;

FIG. 5 is a block diagram showing an exemplary configuration of the image reading apparatus according to the first embodiment of the present invention;

FIG. 6 is a flowchart showing an example of an image reading method for the image reading apparatus according to the first embodiment of the present invention;

FIGS. 7A and 7B are views showing an exemplary arrangement of an original table glass, a white reference board and an alignment marker;

FIG. 8 is a view for explaining a method of combining an R image, a G image and a B image by using marker image data;

FIG. 9 is a flowchart showing another example of an image reading method for the image reading apparatus according to the first embodiment of the present invention;

FIG. 10 is a block diagram showing an exemplary configuration of an image reading apparatus according to a second embodiment of the present invention;

FIG. 11 is a flowchart showing an example of an image reading method for the image reading apparatus according to the second embodiment of the present invention;

FIG. 12 is a block diagram showing an exemplary configuration of an image reading apparatus according to a third embodiment of the present invention;

FIG. 13 is a block diagram showing an exemplary configuration of an image reading apparatus according to a fourth embodiment of the present invention; and

FIG. 14 is a block diagram showing an exemplary configuration of an image forming apparatus according to an embodiment of the present invention.

### DETAILED DESCRIPTION OF THE EMBODIMENTS

Embodiments of an image reading apparatus, image forming apparatus and image reading method according to the present invention will be described with reference to the attached drawings.

### (1) Typical Configuration of Image Reading Apparatus

Prior to explaining an image reading apparatus 1 according to this embodiment, typical two types of apparatuses that read a color original as a color image will be briefly described.

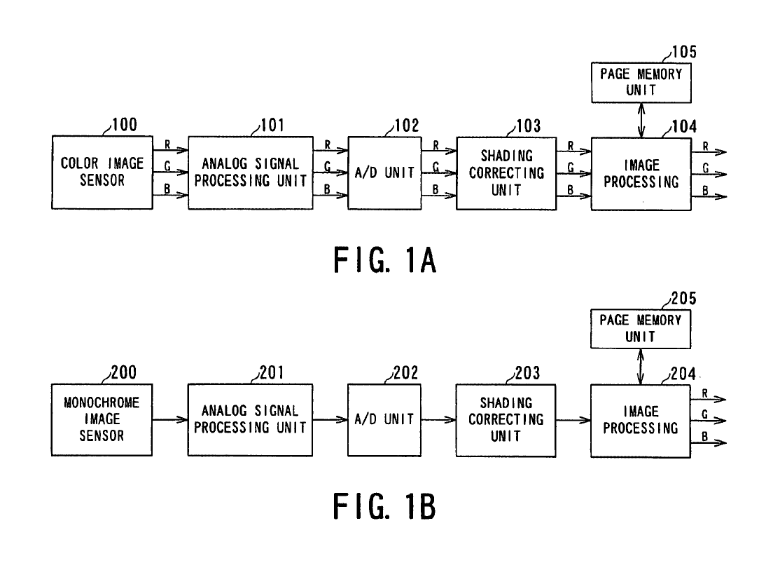

FIG. 1A is a view showing an exemplary configuration of an image reading apparatus of a first type in which a color original is read by color image sensors. In the image reading apparatus of the first type, a color original is read, for example, by three color image sensors 100 of R, G and B, and an R signal, G signal and B signal outputted in parallel from the color image sensors 100 are processed in parallel by an analog signal processing unit 101, A/D unit 102, shading correcting unit 103, image processing unit 104 and the like on the subsequent stages.

On the other hand, FIG. 1B is a view showing an exemplary configuration of an image reading apparatus of a second type in which a color original is read by a monochrome image sensor. In the image reading apparatus of the second type, for example, while three color light sources of R, G and B (not shown) are switched in a short time, reflected light from a color original is read by a monochrome image sensor 200, and an R signal, G signal and B signal outputted serially from the monochrome image sensor 200 are processed serially by an analog signal processing unit 201, A/D unit 202, shading correcting unit 203, image processing unit 204 and the like on the subsequent stages.

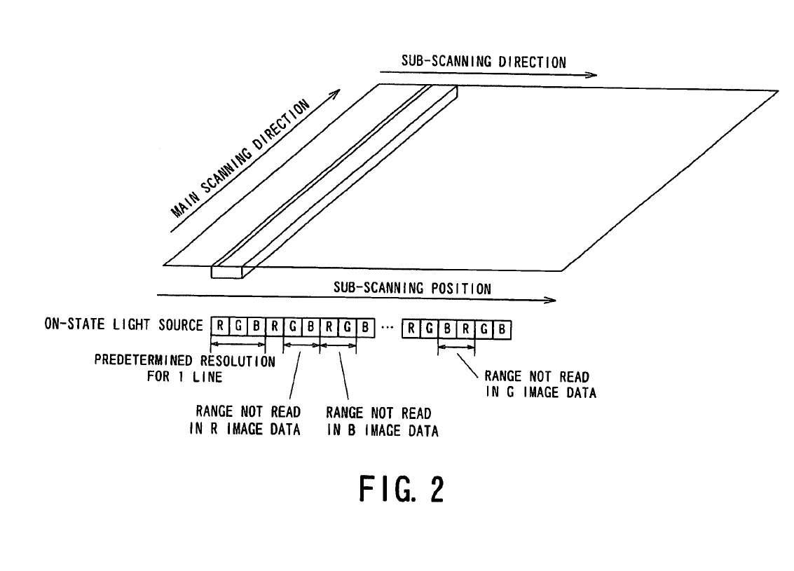

The second type takes a form such that mechanical scanning is carried out in a sub-scanning direction while the linear light sources (three light sources of R, G and B) extending in a main scanning direction are sequentially switched, as illustrated in FIG. 2.

The image reading apparatus of the second type has a simpler configuration than the first type and therefore its cost is generally low. However, it has a disadvantage in image quality, particularly, in resolution, compared with the first type.

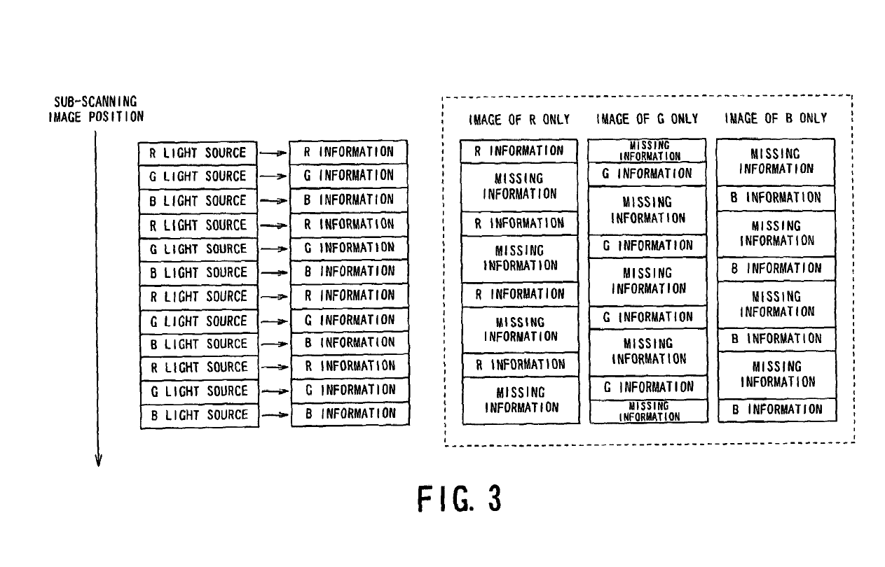

FIG. 3 is a view for explaining the reason for lowering of the resolution in the image reading apparatus of the second type.

In the second type, since scanning is carried out in the sub-scanning direction while the three color light sources of R, G and B are sequentially switched in order of “R light source”, “G light source” and “B light source”, “R information”, “G information” and “B information are outputted in time division in accordance with the switching from the monochrome image. The image processing unit 204 on the subsequent stage takes out only the “R information” of the “B information”, “G information” and “B information” sent in time division, and forms an “R image”. Therefore, the information of the original while the “G light source” and “B light source” are on (“G information” and “B information”) will be missing. Similarly, missing parts will be generated in a “G image” and “B image”. Therefore, to put it simply, the resolution of an image is ⅓ of the resolution in the image reading apparatus of the first type.

The point of the embodiment of the present invention is to realize a configuration based on the second type at a low cost and also realize resolution equivalent to that of the first type. Hereinafter, an image reading apparatus 1 according to an embodiment of the present invention will be described.

### (2) First Embodiment

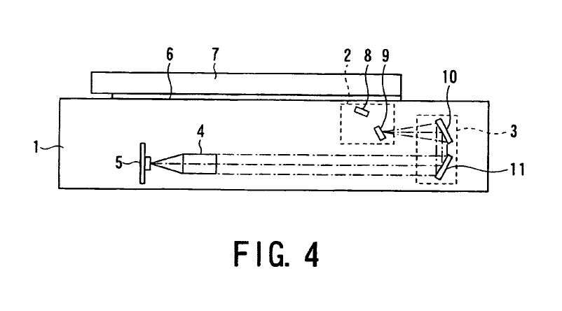

FIG. 4 is a sectional view showing an exemplary structure of the image reading apparatus 1 according to the first embodiment of the present invention.

A color original 300 is put on an original table glass 6 with its written original surface facing downward in the drawing, and as an original holder 7 is closed, the color original 300 is held onto the original table glass 6. The color original 300 is irradiated with a light source 8 and reflected light from the original is converged onto a sensor surface of a monochrome image sensor (one-dimensional image sensor) 5 via mirrors 9, 10 and 11 and a condensing lens 4.

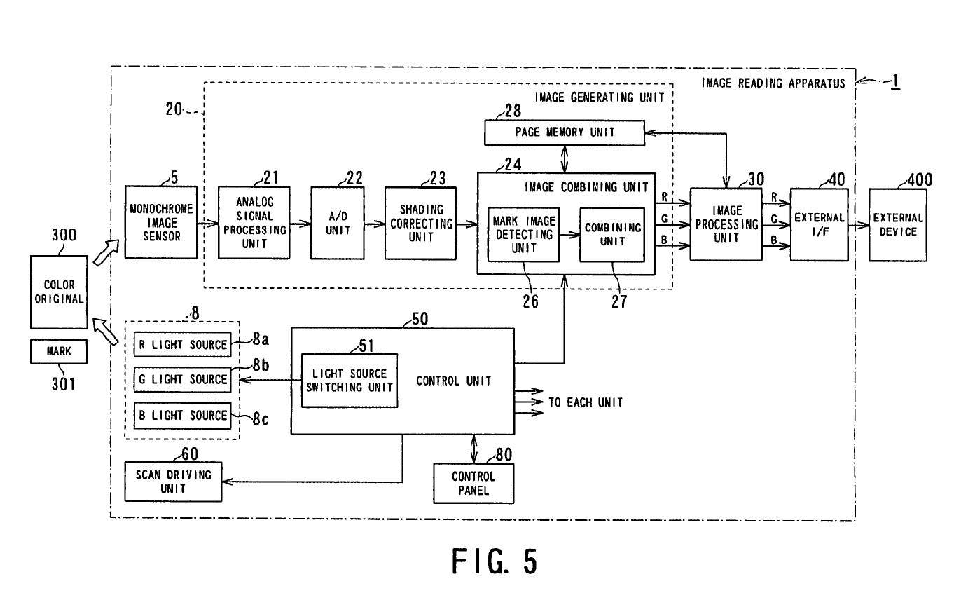

A first carriage 2 including the light source 8 and the mirror 9, and a second carriage 3 including the mirrors 10 and 11 are driven by a motor of a scan driving unit 60 (see FIG. 5) so that their optical path lengths are always constant, and they are caused to mechanically scan from left to right in the drawing with the speed ratio of the first carriage 2 to the second carriage 3 being 2:1.

As a result, the color original 300 put on the original table glass 6 is sequentially read by each main scanning image area (each line) of the monochrome image sensor 5 and converted to an analog electric signal corresponding to the intensity of an optical signal that is the reflected light from the original.

FIG. 5 is a block diagram showing an exemplary system configuration of the image reading apparatus 1 according to the first embodiment of the present invention.

The image reading apparatus 1 has the light source 8 that generates light of plural different colors (R, G and B), the monochrome image sensor 5 that detects reflected light from the color original 300, an image generating unit 20 that generates plural image data (of R, G and B) corresponding to the colors of the light source 8 from a reading signal (analog electric signal) outputted from the monochrome image sensor 5, an image processing unit 30 that performs predetermined image processing to the image data outputted from the image generating unit 20, and an external I/F 40 that functions as an interface with an external device 400.

The image generating unit 20 has, as its internal configuration, an analog signal processing unit 21, an A/D unit 22, a shading correcting unit 23, an image combining unit 24, a page memory unit 28 and the like.

The light source 8 includes three light sources, that is, an R light source 8a, a G light source 8b, and a B light source 8c. The light source 8 is housed in the first carriage 2 and is driven together with the second carriage 3 in the sub-scanning direction by the scan driving unit 60.

The three light sources of the light source 8 are switched in accordance with a command from a light source switching unit 51 of a control unit 50. Also the operation of the scan driving unit 60 is controlled by the control unit 50. The control unit 50 includes a processor (not shown) and also controls the entire image reading apparatus 1 as well as the above-mentioned control.

A control panel 80 that is to be operated by a user is connected to the control unit 50.

The operation of the image reading apparatus 1 configured as described above will be described.

An image signal that is photoelectrically converted to an analog electric signal by the monochrome image sensor 5 is inputted to the analog processing unit 21, and preprocessing for properly converting the analog electric signal outputted from the monochrome image sensor 5 to a digital electric signal by the A/D unit 22 on the subsequent stage is carried out. Specifically, processing such as CDS (correlated double sampling) or sample hold, analog signal amplification, offset elimination and the like is carried out.

The image signal that has been made proper by the analog processing unit 21 is converted to a digital electric signal by the A/D unit 22 and inputted to the shading correcting unit 23.

The shading correcting unit 23 corrects the difference in sensitivity among the pixels in the main scanning direction of the monochrome image sensor 5, uneven illumination of the light source 8 (particularly uneven illumination in the main scanning direction) and the like, for the digital electric signal, which is the image signal.

The image combining unit 24 combines R image data, G image data and B image data outputted from the shading correcting unit 23. In this embodiment, one of the R image data, G image data and B image data is outputted from the shading correcting unit 23 in one sub-scanning operation, and the R image data, G image data and B image data are gathered in three sub-scanning operations. A specific combining method will be described later.

The external device 400 connected to the image reading apparatus 1 may be, for example, a storage device such as a hard disk, flash memory or optical disc device, or a personal computer, printer and the like.

A storage device such as a hard disk, flash memory or optical disc device may be provided within the image reading apparatus 1.

The color original 300 is put on the original table glass 6 and various settings are inputted from the control panel 80. On the control panel 80, for example, setting related to image reading is made, such as reading resolution, original size and the like. The setting information inputted from the control panel 80 is provided to the control unit 50 and a control signal corresponding to the setting information is outputted to each unit.

One reading operation to the color original 300 is carried out as follows.

Then an image reading start signal is inputted from the control panel 80, the light source switching unit 51 of the control unit 50 turns on one of the light sources of the light source 8. After that, the first carriage 2 and the second carriage 3 are driven by the scan driving unit 60 to start scanning in the sub-scanning direction.

The range of scanning by the first carriage 2 and the second carriage 3 is provided in accordance with the original size set by the control panel 80.

As the driving mechanism of the scan driving unit 60, a pulse motor such as a stepping motor is used. In accordance with the number of pulses outputted from an encoder of the stepping motor, the range of scanning corresponding to the original size is managed and the scanning to the end of the original can be controlled.

When the first carriage 2 has reached the end of the original, the control unit 50 issues to the scan driving unit 60 a command to reverse the scanning directions of the first carriage 2 and the second carriage 3 and at the same time, issues a command to turn off the light source 8.

The first carriage 2 and the second carriage 3 with their scanning directions reversed start moving in the direction opposite to the direction for the image reading, and continue moving until an initial position detection output by an optical position detection sensor, not shown, is sent to the control unit 50.

As the control unit 50 receives the initial position detection signal from the optical position detection sensor, the scan driving unit 60 immediately outputs a command to stop the movement of the carriages, and the one image reading operation ends.

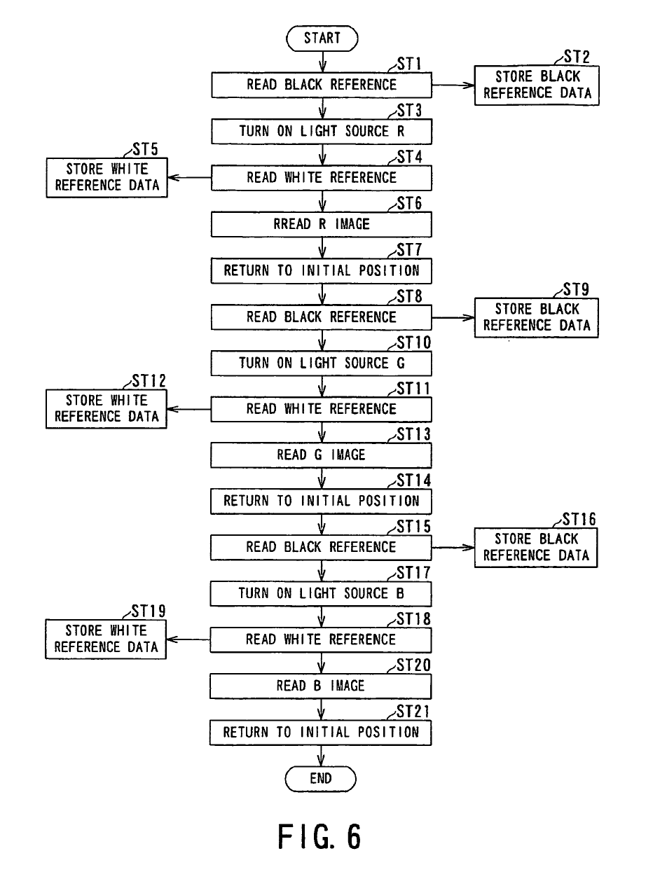

FIG. 6 is a flowchart showing an example of processing in an image reading method by the image reading apparatus 1 according to the first embodiment.

First, black reference data used for shading correction processing is read (step ST1) and the black reference data is stored into a proper memory (step ST2).

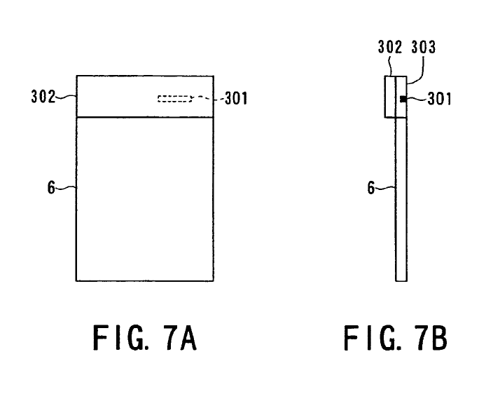

Next, the R light source 8a is turned on (step ST3). After that, white reference board data is read as reflected light of the R light source 8a to a white reference board 302 (see FIGS. 7A and 7B) (step ST4) and the read white reference data is stored (step ST5).

FIG. 7A is a plan view showing the white reference board 302 provided in the image reading apparatus 1 according to the first embodiment and an alignment marker (marker) 301. FIG. 7B is a side view thereof.

The white reference board 302 is arranged at one end (on the reading start position side) of the original table glass 6, and this white reference board 302 is read to acquire white reference data. White reference data is used together with black reference data for shading correction and the like.

Meanwhile, the alignment marker 301 is provided at a part of a white reference board supporting cover 303 that supports the white reference board 302. FIGS. 7A and 7B show a state where the alignment marker 301 is provided at a part in the main scanning direction (longitudinal direction of the white reference board 302). However, a long alignment marker 301 may be provided over the entire area in the main scanning direction.

This alignment marker 301 is read by the R light source 8a in parallel with the reading of the white reference board 302.

The initial position of the R light source 8a is set so that an image of this alignment marker 301, that is, marker image data, is included in read image data (R image data). As the original is read and the R light source 8a moves to the other end of the original table glass 6, the R light source 8a is turned off and it returns to the initial position (step ST7).

Next, after black reference data is acquired and stored (step ST8 and step ST9), the G light source 8b is turned on (step ST10). After that, white reference data is acquired and stored by using the G light source 8b (step ST11 and step ST12), and then the G light source 8b is caused to scan in the sub-scanning direction to read G image data. The marker image data of the alignment marker 301 is also included in this G image data.

B image data is similarly read. In this manner, in the first embodiment, the R light source 8a, G light source 8b and B light source 8c are sequentially turned on and each of them is caused to scan once in the sub-scanning direction, thereby generating three image data of R image, G image and B image from the one color original 300.

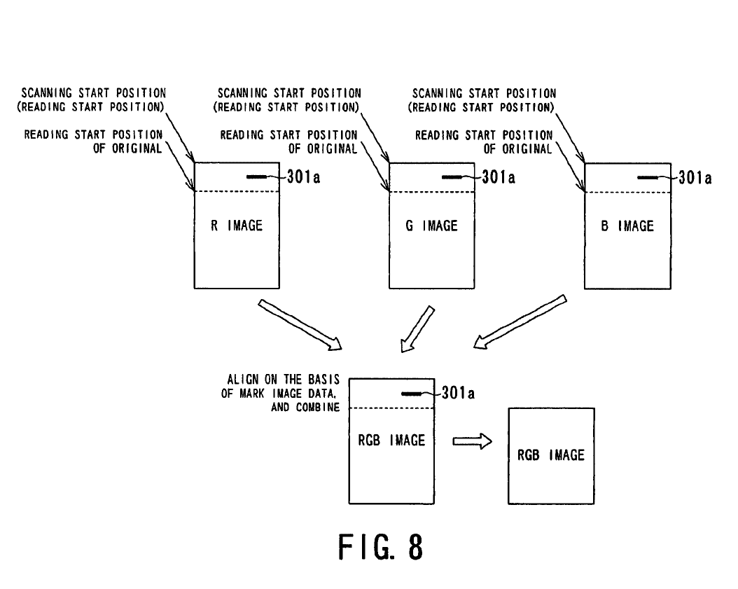

In the upper part of FIG. 8, examples of these three image data are shown. Marker image data 301a acquired by reading the alignment marker 301 is included in each image data.

A marker image detecting unit 26 of the image combining unit 24 detects this marker image data 301a. A combining unit 27 combines the three image data so that the positions of the detected marker image data 301a coincide with each other. Specifically, the sub-scanning line where the marker image data 301a exists is defined as the matching position, and image combination of three colors is carried out with reference to that position.

The marker image data 301a does not originally exist in the original document and is not necessary as scanner information. Thus, unnecessary image information is extracted on the basis of the distance from the marker image data 301a to the original reading start position and is eliminated from the combined RGB image data.

While only one component of R, G or B exists in each pixel of the R image, G image and B image before combination, three components of R, G and B exist in each pixel of the combined RGB image data.

After predetermined image processing is carried out by the image processing unit 30 to the RGB image data thus combined, the RGB image data is outputted to the external device 400 via the external I/F unit 40.

In the flowchart shown in FIG. 6, black reference data used for shading correction is separately acquired in reading of the R image, in reading the G image and in reading the B image. However, each image is acquired when each light source is turned off by using the same monochrome image sensor 5. Therefore, black reference data acquired when reading, for example, the R image may be applied in reading the G image and in reading the B image, instead of repeating acquisition of black reference data when acquiring each color image.

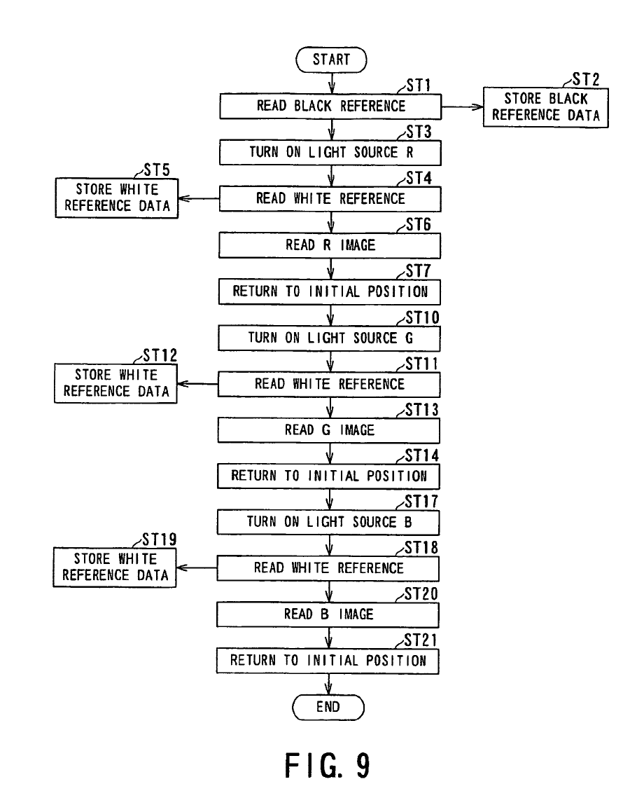

FIG. 9 shows a flowchart in a case of reading black reference data only once in the first reading.

As for white reference data, since it is read by using the light sources of different colors, it must be read in each reading phase of R, G and B.

In the above-described first embodiment, a reduction optical system that causes the light source 8 to do scanning to converge a reduce image onto the fixed monochrome image sensor 5 has been described as an example. However, an equal-size optical system in which the light source 8 and the monochrome image sensor 5 are integrally formed may be provided, and this equal-size optical system may be caused to scan.

### (3) Other Embodiments

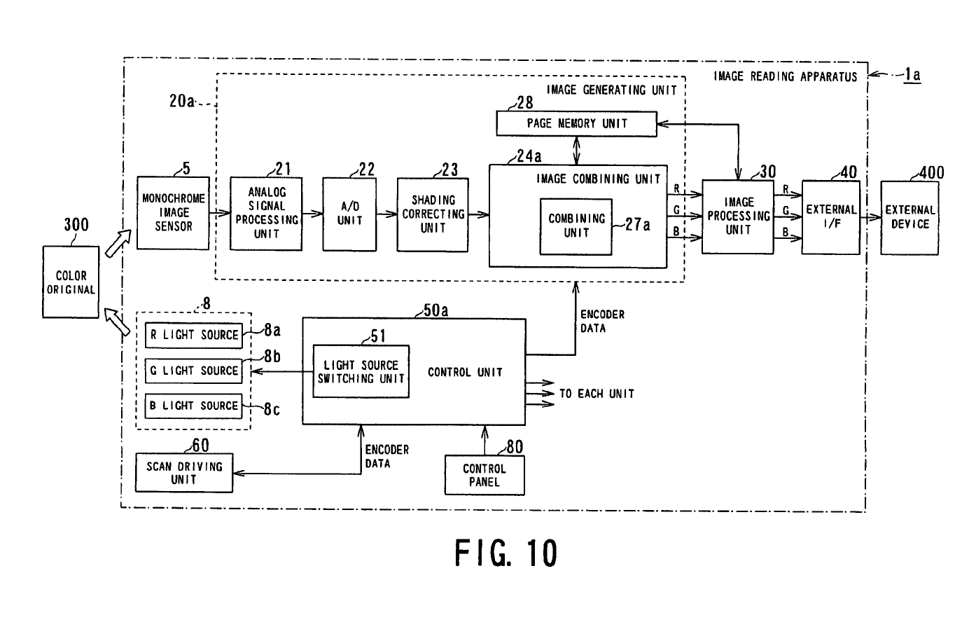

FIG. 10 is a view showing an exemplary configuration of an image reading apparatus la according to a second embodiment.

In the image reading apparatus la according to the second embodiment, an R image, G image and B image are aligned on the basis of position information (scanning position data) from the driving mechanism used in the scan driving unit 60, instead of aligning image positions based on the alignment marker 301 used in the first embodiment. That is, alignment is carried out by using position information of the stepping motor or the like used as the driving mechanism for the first carriage 2, for example, encoder data outputted from the stepping motor.

Therefore, in the second embodiment, the encoder data outputted from the scan driving unit 60 is taken into a control unit 50a and the outputted to an image generating unit 20a, as shown in FIG. 10.

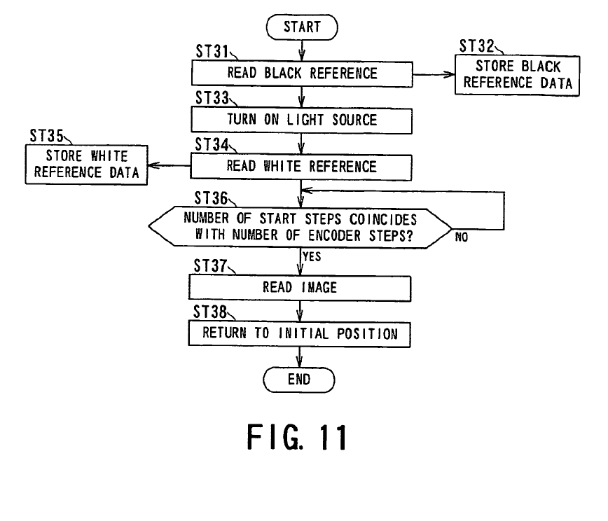

FIG. 11 is a flowchart showing an example of image reading processing by the image reading apparatus 1a according to the second embodiment.

First, the number of encoder pulse steps from the initial position to the original reading start position is calculated in advance and stored into a proper memory in advance.

The processing of steps ST31 to ST35 is the same processing as in the first embodiment.

In step ST36, the number of encoder pulse steps indicating the original reading start position, which has been stored in advance, is compared with the number of encoder pulse steps outputted from the encoder o the scan driving unit 60.

When the two numbers of pulse steps are coincident with each other, it is determined that the light source has reached the image reading start position, and image reading is started. After the reading ends, the light source 8 is turned off and then returned to the initial position. This reading processing is carried out by each of the R light source 8a, G light source 8b and B light source 8c, thus acquiring an R image, G image and B image.

The reading start positions of the acquired R image, G image and B image are coincident with each other because of the above-described determination of coincidence of the numbers of pulse steps. Therefore, as these images are combined from the reading start position, a correctly aligned combined image is provided.

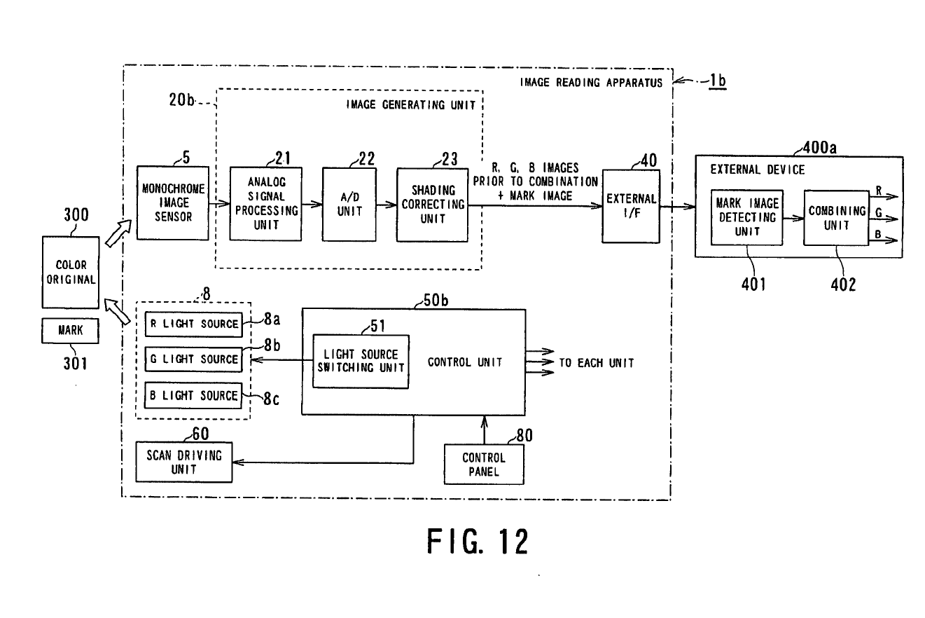

FIG. 12 is a view showing an exemplary configuration of an image reading apparatus 1b according to a third embodiment. In the first embodiment, an R image, G image and B image are combined to an RGB image on the basis of the marker image data 301a and then outputted to the external device 400. However, in the third embodiment, images are combined at an external device 400a.

In the image reading apparatus 1b according to the third embodiment, though turn-on control of the three light sources (R light source 8a, G light source 8b and B light source 8C) is necessary, the other parts of the configuration and processing are substantially the same as those of a monochrome scanner that generates a monochrome image. Therefore, the configuration itself of the image reading apparatus 1b is very simple and can be realized at a low cost.

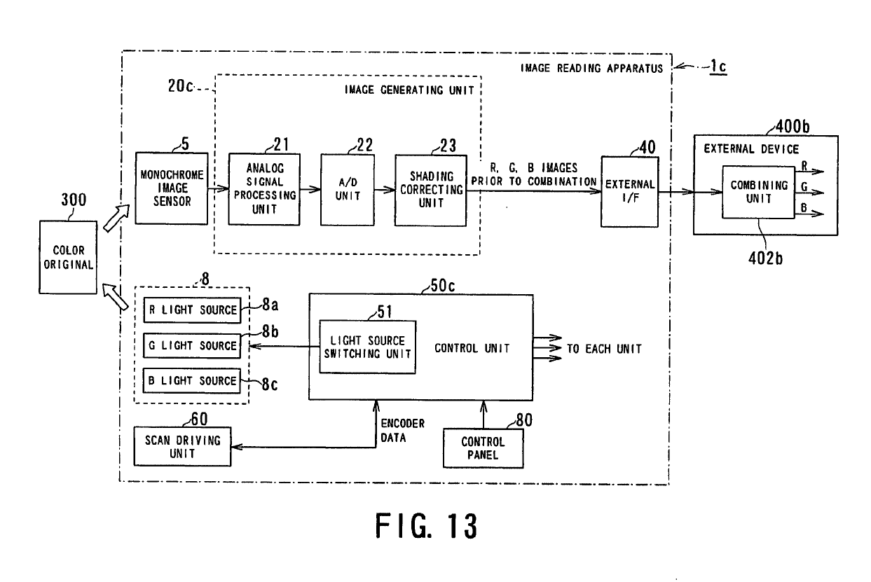

FIG. 13 is a view showing an exemplary configuration of an image reading apparatus 1c according to a fourth embodiment. In the second embodiment, the image reading start positions of an R image, G image and B image are decided on the basis of encoder data outputted from the scan driving unit 60, and the respective images aligned by this are combined and then outputted to the external device 400. However, in the fourth embodiment, image combining itself is carried out by a combining unit 402b of the external device 400a.

The image reading apparatus 1c according to the fourth embodiment has a simple configuration as well as in the third embodiment, and the image reading apparatus 1c of a low cost can be realized.

### (4) Image Forming Apparatus

Up to this point, the image reading apparatus such as a scanner device or the like has been described. However, this embodiment of the present invention can also be applied to an image forming apparatus such as a copier device or the like.

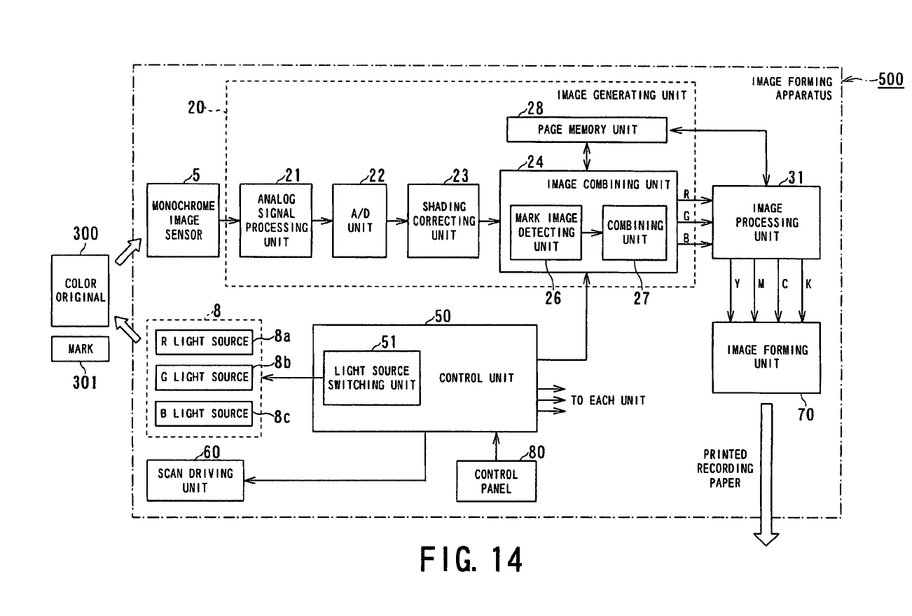

FIG. 14 is a view showing an exemplary configuration of an image forming apparatus 500 according to an embodiment of the present invention.

In this embodiment, as in the image reading apparatus 1, the image combining unit 24 combines an R image, G image and B image into an RGB image on the basis of the marker image data 301a. After that, the image processing unit 31 performs image processing such as color conversion processing from R, G, B to Y, M, C, K, and furthermore, an image forming unit 70 using an electrophotographic system or the like prints a color image on a recording paper.

As the image combining method, images may be combined by using encoder data of the scan driving unit 60, as in the image reading apparatus 1a according to the second embodiment.

In the image forming apparatus 500 according to this embodiment, even when printing a color original as a color image, the image generating unit 20 can be configured as simply as the one for monochrome image without degrading the resolution of the image.

As is described above, with the image reading apparatus, image forming apparatus and image reading method according to the embodiments, good image quality can be realized even in the case of reading a color original as a color image by using one monochrome image sensor.

The present invention is not limited to the embodiments themselves and components can be modified and embodied in practice without departing from the scope of the present invention. Also, various embodiments of the present invention can be formed by properly combining plural components disclosed in the above embodiments. For example, some of all the components disclosed in each embodiment may be eliminated. Moreover, components of different embodiments can be properly combined.

What is claimed is:

1. An image reading apparatus for reading a color original, comprising:
plural light sources of different colors;
a monochrome image sensor configured to detect reflected light from the color original;
an image generating unit configured to generate plural image data corresponding to the colors of the plural light sources from a reading signal outputted from the monochrome image sensor; and
a control unit configured to turn on the light sources one by one and cause the image generating unit to generate, one by one, the image data corresponding to the colors of the light sources.

2. The image reading apparatus according to claim 1, further comprising a scan driving unit configured to cause at least either the plural light sources or the monochrome image sensor to mechanically scan in a sub-scanning direction in order to read the color original,
wherein the control unit causes the image data to be generated one by one at each time of the scanning.

3. The image reading apparatus according to claim 1, further comprising a marker fixed at a position in an area that can be read by the monochrome image sensor and that does not affect the image data of the color original,
wherein marker image data of the marker is included in each of the plural image data.

4. The image reading apparatus according to claim 1, further comprising an image data combining unit configured to combine the plural image data and thus generate a color image.

5. The image reading apparatus according to claim 3, further comprising an image data combining unit configured to combine the plural image data and thus generate a color image, wherein the image data combining unit aligns the plural image data on the basis of the marker image data and combines the plural image data.

6. The image reading apparatus according to claim 2, further comprising an image data combining unit configured to combine the plural image data and thus generate a color image,
wherein the image data combining unit aligns the plural image data on the basis of scanning position data outputted from the scan driving unit and combines the plural image data.

7. The image reading apparatus according to claim 1, wherein in reading the plural image data, reading of black reference data is carried out only once.

8. An image forming apparatus for reading a color original and forming a color image, comprising:
plural light sources of different colors;
a monochrome image sensor configured to detect reflected light from the color original;
an image generating unit configured to generate plural image data corresponding to the colors of the plural light sources from a reading signal outputted from the monochrome image sensor;
a control unit configured to turn on the light sources one by one and cause the image generating unit to generate, one by one, the image data corresponding to the colors of the light sources;
an image data combining unit configured to combine the plural image data and thus generate a color image; and
an image forming unit configured to print the combined color image onto a recording medium.

9. The image forming apparatus according to claim 8, further comprising a scan driving unit configured to cause at least either the plural light sources or the monochrome image sensor to mechanically scan in a sub-scanning direction in order to read the color original,
wherein the control unit causes the image data to be generated one by one at each time of the scanning.

10. The image forming apparatus according to claim 8, further comprising a marker fixed at a position in an area that can be read by the monochrome image sensor and that does not affect the image data of the color original,
wherein marker image data of the marker is included in each of the plural image data.

11. The image forming apparatus according to claim 10, wherein the image data combining unit aligns the plural image data on the basis of the marker image data and combines the plural image data.

12. The image forming apparatus according to claim 9, wherein the image data combining unit aligns the plural image data on the basis of scanning position data outputted from the scan driving unit and combines the plural image data.

13. An image reading method for reading a color original, comprising the steps of:
turning on plural light sources of different colors one by one and irradiating the color original;
detecting reflected light from the color original by using a monochrome image sensor; and
generating, one by one, the image data corresponding to the colors of the light sources at the turning on of each of the light sources, from a reading signal outputted from the monochrome image sensor.

14. The image reading method according to claim 13, further comprising the step of causing at least either the plural light sources or the monochrome image sensor to mechanically scan in a sub-scanning direction in order to read the color original,
wherein the step of generating the image data one by one includes generating the image data one by one at each time of the scanning.

15. The image reading method according to claim 13, wherein marker image data of a marker fixed at a position in an area that can be read by the monochrome image sensor and that does not affect the image data of the color original, is included in each of the plural image data.

16. The image reading method according to claim 13, further comprising the step of combining the plural image data and thus generating a color image.

17. The image reading method according to claim 15, further comprising the step of combining the plural image data and thus generating a color image,
wherein the step of generating a color image includes aligning the plural image data on the basis of the marker image data and combining the plural image data.

18. The image reading method according to claim 14, further comprising the step of combining the plural image data and thus generating a color image,
wherein the step of generating a color image includes aligning the plural image data on the basis of scanning position data outputted in the step of mechanically scanning, and combining the plural image data.

19. The image reading method according to claim 13, wherein black reference image data is included in one of the plural image data.
